(19) United States
(12) Patent Application Publication
(10) Pub. No.: US 2026/0320985 A1
(43) Pub. Date: Oct. 15, 2026

(54) OBJECT DETECTION MODEL EVALUATION APPARATUS AND METHOD FOR SERVICE DISTRIBUTION

(71) Applicants: HYUNDAI MOTOR COMPANY, Seoul (KR); Kia Corporation, Seoul (KR)

(72) Inventors: Jingang HUH, Hwaseong-si (KR); Jiwon KIM, Hwaseong-si (KR); Moonsub JIN, Hwaseong-si (KR); Keonho LEE, Hwaseong-si (KR)

(21) Appl. No.: 19/404,871

(22) Filed: Dec. 1, 2025

(30) Foreign Application Priority Data
Apr. 9, 2025 (KR) 10-2025-0045984

(51) Int. Cl. G06V 10/776; G06V 10/764; G06V 10/774

(52) U.S. Cl. CPC G06V 10/776; G06V 10/774; G06V 10/764

(57) ABSTRACT

An object detection model evaluation apparatus for service distribution includes one or more memory devices storing program codes and one or more processors configured to execute the program codes to perform operations. The operations include generating a data set based on a predefined service environment prior to service distribution, designing difficulty levels for object detection based on the predefined service environment, classifying annotations within the data set based on the designed difficulty levels, determining applicability of an object detection model to a predefined scenario based on the classified annotations, and determining availability of the applicable object detection model on a target device.

### CROSS-REFERENCE TO RELATED APPLICATION

This application claims priority to and the benefit of Korean Patent Application No. 10-2025-0045984 filed with the Korean Intellectual Property Office on Apr. 9, 2025, the entire contents of which are incorporated herein by reference.

### TECHNICAL FIELD

The present disclosure relates to an object detection model evaluation apparatus and method for service distribution, and more specifically, to an object detection model evaluation apparatus and method for service distribution that reduces errors during real-world service execution by constructing evaluation datasets tailored to service environments and using these datasets to assess model performance before distribution.

### BACKGROUND

Conventional approaches to objection detection model deployment involve training a neural network using publicly available datasets, followed by evaluation using predefined metrics.

These methods often fail to account for domain discrepancies between the training datasets and the actual service environments in which the models are deployed.

Such domain gaps can result in unpredictable performance and errors during real-world operation. For example, a model trained and validated using public or randomly sampled datasets may not generalize well to a specific service scenarios, leading to degraded accuracy and reliability.

### SUMMARY

The present disclosure is directed to an object detection model evaluation apparatus and method for service distribution. The apparatus is configured to design evaluation metrics that reflect minimum performance requirements of a model within a target service environment. Using these metrics, the apparatus constructs a self-evaluation dataset tailored to the service context. The object detection model is then evaluated against this data set to determine to determine its suitability for deployment. By incorporating service-specific evaluation criteria and datasets, the disclosed apparatus ensures that only models meeting predefined performance thresholds are distributed, thereby enhancing reliability and reducing errors in real-world applications.

According to one aspect of the present disclosure, an object detection model evaluation apparatus for service distribution can include one or more memory devices storing program codes, and one or more processors configured to execute the program codes to perform operations. The operations can include generating a data set based on a predefined service environment prior to service distribution, designing difficulty levels for object detection based on the predefined service environment, classifying annotations within the data set based on the designed difficulty levels, determining applicability of an object detection model to a predefined scenario based on the classified annotations, and determining availability of the applicable object detection model on a target device.

In some implementations, designing the difficulty levels can include determining the difficulty levels based on at least one of a size of an input image, a number of objects, or a size of a bounding box for a single object. In some examples, designing the difficulty levels can further include increasing the difficulty levels in proportion to a number of occlusions, which are objects overlapping each other.

In some examples, classifying the annotations can include classifying, among the difficulty levels, (i) a first difficulty level that do not exceed a predetermined first threshold as a first level, (ii) a second difficulty level that exceeds the first threshold and that does not exceed a predetermined second threshold as a second level, and (iii) a third difficulty level that exceeds the predetermined second threshold as a third level. In some examples, classifying the annotations can further include setting the first threshold and the second threshold so that the first level, the second level, and the third level each occupy a specific percentage based on a histogram of the difficulty levels.

In some implementations, determining the applicability of the object detection model can include, for each level, evaluating the object detection model by using an average precision (AP) or mean average precision (mAP) index. In some examples, determining the applicability of the object detection model can further include, based on the evaluation of the object detection model for a first level being failed, re-learning the object detection model, based on the evaluation for the first level being successful, performing the evaluation for a second level, based on the evaluation for the second level being failed, evaluating the object detection model to be applicable to a first scenario, and, based on the evaluation for the second level being successful, performing the evaluation for a third level to evaluate whether the object detection model is applied to a second scenario or a third scenario according to whether the evaluation for the third level is successful.

In some implementations, determining the availability of the applicable object detection model can include optimizing the object detection model with a layer supported by the target device. In some examples, determining the availability of the applicable object detection model can further include inferring using an optimized object detection model, and determining whether to use the object detection model in the target device based on a speed of inference and memory usage. In some implementations, designing the difficulty levels can include calculating the difficulty levels by using Equation 1,

$${Difficulty}_{i} = log ( \frac{image size + α \cdot {\sum }_{n} occlusion {area}_{n}}{bbox {size}_{i}} + 1 ) + log ( N + 1 ) \qquad [ Equation 1 ]$$

where Difficulty can refer to the difficulty levels, an occlusion area can refer to an area that overlaps other objects based on a specific object, an image size can refer to an overall size of an image, a bbox size can refer to a size of a bounding box of a single object, N can be the number of all objects in the image, and a can be a scale parameter for a small occlusion area compared to the image size.

According to another aspect of the present disclosure, an object detection model evaluation method for service distribution that is performed by a computing device including a processor and a memory can include designing, by the processor, difficulty levels for object detection based on a predefined service environment, classifying, by the processor, annotations based on the designed difficulty levels, determining, by the processor, applicability of an object detection model to a predefined scenario based on the classified annotations, and determining, by the processor, availability of the applicable object detection model on a target device.

In some implementations, designing the difficulty levels can include determining the difficulty levels based on at least one of a size of an input image, a number of objects, or a size of a bounding box for a single object. In some examples, designing the difficulty levels can further include increasing the difficulty levels in proportion to a number of occlusions, which are objects overlapping each other.

In some examples, classifying the annotations can include classifying, among the difficulty levels, (i) a first difficulty level that do not exceed a predetermined first threshold as a first level, (ii) a second difficulty level that exceeds the first threshold and that does not exceed a predetermined second threshold as a second level, and (iii) a third difficulty level that exceeds the predetermined second threshold as a third level. In some examples, classifying the annotations can further include setting the first threshold and the second threshold so that the first level, the second level, and the third level each occupy a specific percentage based on a histogram of the difficulty levels.

In some implementations, determining the applicability of the object detection model can include, for each level, evaluating the object detection model by using an average precision (AP) or mean average precision (mAP) index. In some examples, determining the applicability of the object detection model can further include, based on the evaluation of the object detection model for a first level being failed, re-learning the object detection model, based on the evaluation for the first level being successful, performing the evaluation for a second level, based on the evaluation for the second level being failed, evaluating the object detection model to be applicable to a first scenario, and, based on the evaluation for the second level being successful, performing the evaluation for a third level to evaluate whether the object detection model is applied to a second scenario or a third scenario according to whether the evaluation for the third level is successful.

In some implementations, determining the availability of the applicable object detection model can include optimizing the object detection model with a layer supported by the target device. In some examples, determining the availability of the applicable object detection model can further inferring using an optimized object detection model, and determining whether to use the object detection model in the target device based on a speed of inference and memory usage. In some examples, designing the difficulty levels can include calculating the difficulty levels by using Equation 1,

$${Difficulty}_{i} = log ( \frac{image size + α \cdot {\sum }_{n} occlusion {area}_{n}}{bbox {size}_{i}} + 1 ) + log ( N + 1 ) \qquad [ Equation 1 ]$$

Where Difficulty can refer to the difficulty levels, an occlusion area can refer to an area that overlaps other objects based on a specific object, an image size can refer to an overall size of an image, a bbox size can refer to a size of a bounding box of a single object, N can be the number of all objects in the image, and a can be a scale parameter for a small occlusion area compared to the image size.

The object detection model evaluation apparatus and method for service distribution can design an index capable of ensuring the minimum performance of the model in a service environment, build a self-evaluation data set based on the designed index, and use the self-evaluation data set to service distribute a model with guaranteed learning performance.

### BRIEF DESCRIPTION OF THE DRAWINGS

FIG. 1 is a block diagram illustrating an example of an object detection model evaluation apparatus for service distribution.

FIG. 2 is a diagram illustrating an example of an annotation classification method through an annotation classification module.

FIG. 3 is a diagram illustrating an example of a method of calculating difficulty levels of FIG. 2.

FIG. 4 is a flowchart illustrating an example of an operation of a scenario-based model evaluation module.

FIG. 5 is a flowchart illustrating an example of an evaluation method of FIG. 4.

FIG. 6 is a flowchart illustrating an example of an operation of a device-based model evaluation module.

FIG. 7 is a flowchart illustrating an example of a model evaluation method of FIG. 6.

FIG. 8 is a flowchart illustrating an example of an object detection model evaluation method for service distribution.

FIG. 9 is a diagram illustrating an example of a computing device.

### DETAILED DESCRIPTION

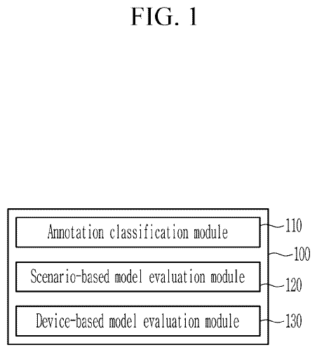

FIG. 1 is a block diagram illustrating an example of an object detection model evaluation apparatus for service distribution.

Referring to FIG. 1, an object detection model evaluation apparatus 100 for service distribution can execute a program code or instruction stored in one or more memory devices through one or more processors.

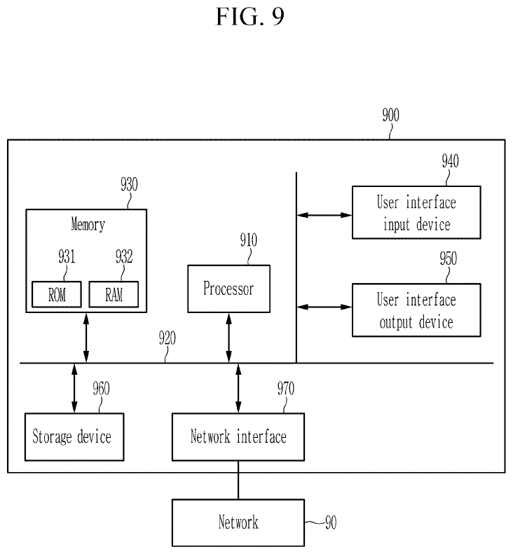

The object detection model evaluation apparatus 100 for service distribution can be implemented with a computing device 900 as described later with reference to FIG. 9. In some implementations, one or more processors can correspond to a processor 910 of the computing device 900, and the one or more memory devices can correspond to a memory 930 of the computing device 900.

The program code or instruction can be executed by one or more processors to generate a data set based on a predetermined service environment prior to service distribution and evaluate an object detection model based on the generated data set.

Referring to FIG. 1, the object detection model evaluation apparatus 100 for service distribution can include an annotation classification module 110, a scenario-based model evaluation module 120, and a device-based model evaluation module 130.

The annotation classification module 110 can design difficulty levels of object detection based on a service environment, and classify an annotation based on the designed difficulty levels.

In some implementations, annotation can refer to an operation of designating a location and a class of an object in an image for model learning.

Annotation can display an object in the form of a bounding box or polygon in an image, and include a label for the corresponding object.

The annotation can be provided as a JSON file in a common objects in context (COCO) format.

The annotation classification module 110 can classify an annotation based on a difficulty index in consideration of a service environment.

The annotation classification module 110 can determine the difficulty levels based on at least one of a size of an input image, the number of objects, or a size of a bounding box for a single object.

The annotation classification module 110 can increase the difficulty levels in proportion to the number of occlusions, which are objects overlapping each other.

The annotation classification module 110 can calculate the difficulty levels using Equation 1.

$${Difficulty}_{i} = log ( \frac{image size + α \cdot {\sum }_{n} occlusion {area}_{n}}{bbox {size}_{i}} + 1 ) + log ( N + 1 ) \qquad [ Equation 1 ]$$

For example, Difficulty can refer to the difficulty levels, the occlusion area can refer to an area that overlaps other objects based on a specific object, the image size can refer to the overall size of the image, the bbox size can refer to the size of the bounding box of a single object, N can refer to the number of all objects in the image, and a can refer to a scale parameter for a small occlusion area compared to the image size.

The annotation classification module 110 can classify, among the difficulty levels, (i) a first difficulty level that does not exceed a predetermined first threshold as a first level, (ii) a second difficulty level that exceeds the first threshold and does not exceed a predetermined second threshold as a second level, and (iii) a third difficulty level that exceeds the second threshold as a third level.

The annotation classification module 110 can set the first threshold and the second threshold so that the first level, the second level, and the third level each occupy a specific percentage based on the histogram of the difficulty levels.

For example, the annotation classification module 110 can determine the first threshold and the second threshold such that the first difficulty level (mandatory) occupies 50%, the second difficulty level (recommended) occupies 30%, and the third difficulty level (optional) occupies 20%, based on the histogram of the difficulty levels.

The scenario-based model evaluation module 120 can determine applicability of an object detection model to a predefined scenario based on the classified annotation.

The scenario-based model evaluation module 120 can evaluate the object detection model by using an average precision (AP) or a mean average precision (mAP) index for each level.

The scenario-based model evaluation module 120 may re-learn the object detection model when evaluation of the object detection model with respect to the first level fails.

The scenario-based model evaluation module 120 may perform an evaluation for the second level when the evaluation for the first level is successful.

When the evaluation for the second level fails, the scenario-based model evaluation module 120 may evaluate that the object detection model may be applied to a first scenario.

When the evaluation for the second level is successful, the scenario-based model evaluation module 120 may perform the evaluation for the third level and evaluate whether the object detection model is applied to a second scenario or a third scenario according to whether the evaluation for the third level is successful.

The device-based model evaluation module 130 can determined availability of the applicable object detection model can be used in the device.

The device-based model evaluation module 130 can optimize the object detection model with a layer supported by the device.

The device-based model evaluation module 130 can infer using the optimized object detection model, and determine whether to use the object detection model in the device based on the speed of inference and memory usage.

For example, the device-based model evaluation module 130 can perform layer fusion, quantization, etc. before distributing the service for the models determined to be determinable by the scenario-based model evaluation module 120 and determine whether the models are available in the service device.

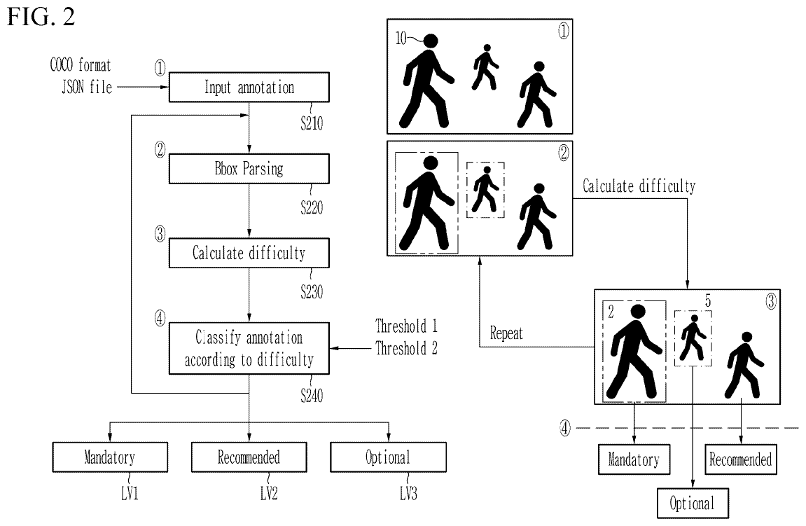

FIG. 2 is a diagram illustrating an example of an annotation classification method through the annotation classification module.

The annotation classification method of FIG. 2 can be performed by the object detection model evaluation apparatus 100 for service distribution of FIG. 1. In some implementations, the annotation classification method of FIG. 2 can be performed by the annotation classification module 110 of FIG. 1.

In FIG. 2, the object detection model evaluation apparatus 100 for service distribution can input an annotation of the object 10 using a JSON file in a common objects in context (COCO) format (operation S210).

The object detection model evaluation apparatus 100 for service distribution can extract bounding box information from the annotation data of the object detection model and process the extracted bounding box (operation S220).

The object detection model evaluation apparatus 100 for service distribution can calculate the difficulty levels for the extracted bounding box (operation S230).

The object detection model evaluation apparatus 100 for service distribution can perform annotation classification based on the difficulty levels calculated for each object (operation S240).

The object detection model evaluation apparatus 100 for service distribution can distinguish Mandatory (LV1) of the first difficulty level and Recommended (LV2) of the second difficulty level based on a threshold (Threshold 1) according to a first difficulty.

The object detection model evaluation apparatus 100 for service distribution can distinguish Recommended (LV2) of the second difficulty level and Optional (LV3) of the third difficulty level based on a second threshold (Threshold 2) according to the difficulty levels.

For example, the object detection model evaluation apparatus 100 for service distribution can classify the object of difficulty 2 as Mandatory and the object of difficulty 5 as Optional.

The object detection model evaluation apparatus 100 for service distribution can repeat operations S220 to S240 to perform annotation classification.

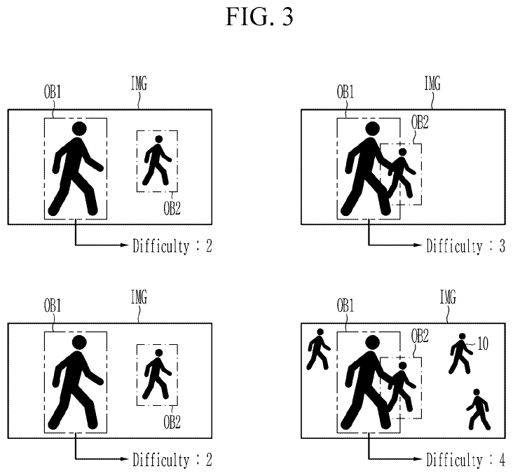

FIG. 3 is a diagram illustrating an example of a method of calculating the difficulty levels of FIG. 2.

In FIG. 3, the object detection model evaluation apparatus 100 for service distribution can determine different difficulty levels for a first object OB1 and a second object OB2 designated as a bounding box in the image IMG.

The object detection model evaluation apparatus 100 for service distribution can determine the difficulty levels based on the size of the image IMG and the size of the bounding box.

For example, the object detection model evaluation apparatus 100 for service distribution can estimate the distance between an object and a camera through the size of the bounding box.

The object detection model evaluation apparatus 100 for service distribution can determine the difficulty level to be relatively small for an object close to the camera.

For example, the object detection model evaluation apparatus 100 for service distribution can determine the difficulty level of the first object OB1 having a large bounding box and a close distance to the camera as 2, and determine the difficulty level of the second object OB2 having a relatively small bounding box and a far distance to the camera to be greater than 2.

When there is an occlusion area (overlapping area), the object detection model evaluation apparatus 100 for service distribution can determine the difficulty level higher than the case where there is no occlusion area (overlapping area).

The object detection model evaluation apparatus 100 for service distribution can determine the difficulty level as 2 when there is no overlapping area for the first object OB1, but determine the difficulty level as 3 when there is an area overlapping the second object OB2.

The object detection model evaluation apparatus 100 for service distribution can increase the difficulty level of the object as the number of all objects existing in the image IMG increases.

For example, the object detection model evaluation apparatus 100 for service distribution can determine the difficulty level as 3 when there are no objects 10 other than the second object OB2 overlapping the first object around the first object OB1 in the image IMG.

In some implementations, the object detection model evaluation apparatus 100 for service distribution can determine the difficulty level as 4 greater than 3 when there are more objects 10 other than the second object OB2 overlapping around the first object OB1 in the image IMG.

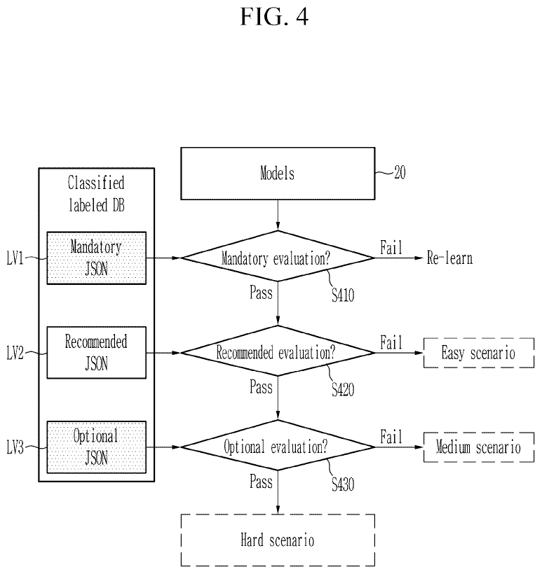

FIG. 4 is a flowchart illustrating an example of an operation of a scenario-based model evaluation module. The scenario-based model evaluation method of FIG. 4 can be performed by the object detection model evaluation apparatus 100 for service distribution of FIG. 1, and for example, by the scenario-based model evaluation module 120.

In FIG. 4, the labeled DB according to the annotation classification can include the Mandatory JSON file of the first level (LV1), the Recommended JSON file of the second level (LV2), and the Optional JSON file of the third level (LV3).

The object detection model evaluation apparatus 100 for service distribution can perform scenario evaluation on the deep learning models 20 for object detection based on the classified labeled DB.

The object detection model evaluation apparatus 100 for service distribution can evaluate the deep learning model 20 by using an average precision (AP) or a mean average precision (mAP) index in each evaluation flowchart for the classified labeled DB to consider the service environment.

The object detection model evaluation apparatus 100 for service distribution can output Pass or Fail as an evaluation result.

The object detection model evaluation apparatus 100 for service distribution may re-learn the object detection model when the evaluation for the first level (Mandatory evaluation) fails with respect to the deep learning model 20, and may perform the evaluation for the second level (Recommended evaluation) when the evaluation for the first level (Mandatory evaluation) is successful (operation S410).

The object detection model evaluation apparatus 100 for service distribution may evaluate that the deep learning model 20 is applicable to the first scenario (Easy scenario) when the evaluation for the second level (Recommended evaluation) fails, and may perform an evaluation for the third level (Optional evaluation) when the evaluation for the second level (Recommended evaluation) is successful (operation S420).

When the evaluation for the third level (Optional evaluation) fails, the object detection model evaluation apparatus 100 for service distribution may evaluate that the deep learning model 20 may be applied to the second scenario (Medium scenario).

The object detection model evaluation apparatus 100 for service distribution may evaluate that the deep learning model 20 may be applied to the third scenario (Hard scenario) when the evaluation for the third level (Optional evaluation) is successful.

The object detection model evaluation apparatus 100 for service distribution can apply the deep learning model 20 to the Easy, Medium, or Hard scenarios according to the service difficulty when the result of the evaluation for the first level (Mandatory evaluation) indicates failure.

Examples of Easy/Medium/Hard scenarios may be single class detection/multi-class detection/pose estimation detection, and the like, respectively.

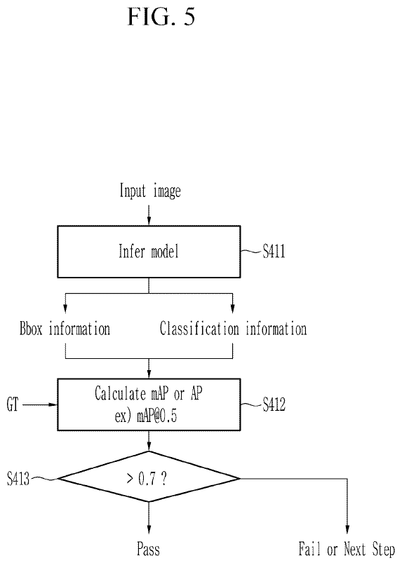

FIG. 5 is a flowchart illustrating an example of the evaluation method of FIG. 4. FIG. 5 illustrates an evaluation method of the first level evaluation (Mandatory evaluation) as an example.

In FIG. 5, the object detection model evaluation apparatus 100 for service distribution can perform model inference on the deep learning model 20 (see FIG. 4) (operation S411).

The object detection model evaluation apparatus 100 for service distribution can calculate an average precision (AP) or a mean average precision (mAP) index based on bounding box information and classification information with respect to the deep learning model inference result (operation S412).

The object detection model evaluation apparatus 100 for service distribution can output Pass when a calculation result value is greater than a reference value considering the service environment, and output Fail when the calculation result value is less than or equal to the reference value (operation S413).

For example, the object detection model evaluation apparatus 100 for service distribution can output pass when the calculation result value is greater than 0.7, and output fail when the calculation result value is smaller than or equal to 0.7.

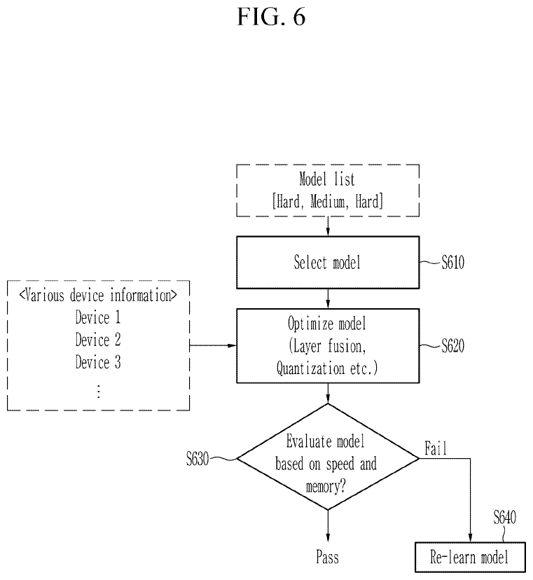

FIG. 6 is a flowchart illustrating an example of an operation of the device-based model evaluation module.

The object detection model evaluation apparatus 100 for service distribution can select a device evaluation target model when a list of deep learning models determined to be applicable to the Easy scenario, the Medium scenario, or the Hard scenario is received (operation S610).

For example, the object detection model evaluation apparatus 100 for service distribution can measure whether a service is possible in a target device only for verified models.

The object detection model evaluation apparatus 100 for service distribution can retrieve information on various devices including the target device, and optimize the model (using Layer Fusion, Quantization, etc.) with a layer supportable by the target device (operation S620).

The object detection model evaluation apparatus 100 for service distribution can measure the speed and memory usage and evaluate the model based on the measured speed and memory usage (operation S630).

The object detection model evaluation apparatus 100 for service distribution can output the evaluation result to Pass or Fail, and when Fail is output, the object detection model evaluation apparatus 100 for service distribution may request to perform re-learning by changing the model (operation S640).

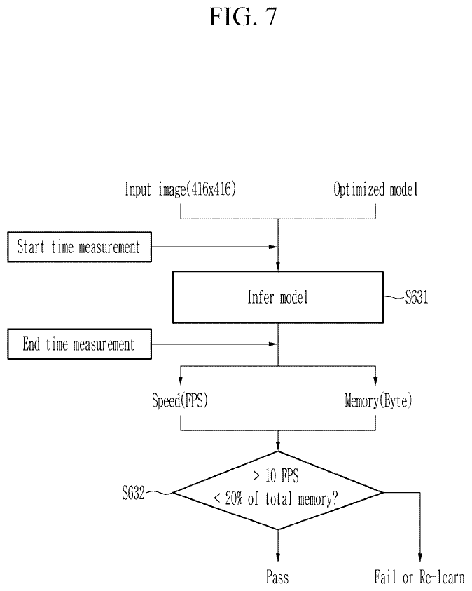

FIG. 7 is a flowchart illustrating an example of the model evaluation method based on the speed and the memory usage of FIG. 6.

In FIG. 7, the object detection model evaluation apparatus 100 for service distribution can perform model inference with an input image (e.g., 416×416) and the previously optimized model (operation S631).

The object detection model evaluation apparatus 100 for service distribution can start time measurement prior to model inference and end the time measurement at the end of model inference to measure the time taken for inference.

The object detection model evaluation apparatus 100 for service distribution can check the measured speed (FPS) and the memory usage (Byte) after the inference is completed, and determine whether the speed is greater than a predetermined reference speed in consideration of the service environment and whether the memory usage is less than a predetermined reference usage in consideration of the service environment (operation S632).

For example, the object detection model evaluation apparatus 100 for service distribution can output Pass when the speed is greater than 10 FPS and the memory usage is less than 20% of the total memory, and otherwise, may request fail or re-learning.

The object detection model evaluation apparatus 100 for service distribution can evaluate that the corresponding model may be used in the target device when the Pass is finally output.

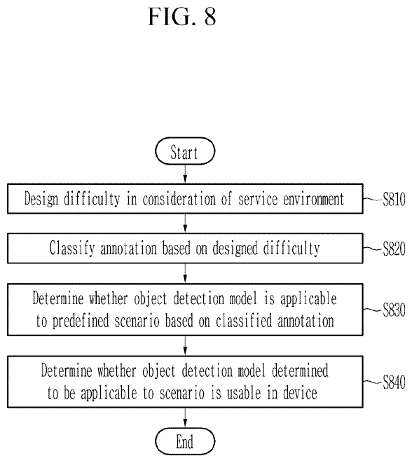

FIG. 8 is a flowchart illustrating an example of an object detection model evaluation method for service distribution. The object detection model evaluation method for service distribution of FIG. 8 can be performed by the object detection model evaluation apparatus 100 for service distribution of FIG. 1.

In FIG. 8, the object detection model evaluation apparatus 100 for service distribution can design the difficulty levels for object detection based on the service environment (operation S810).

The object detection model evaluation apparatus 100 for service distribution can classify an annotation based on the designed difficulty levels (operation S820).

The object detection model evaluation apparatus 100 for service distribution can determine applicability of the object detection model to a predefined scenario based on the classified annotation (operation S830).

The object detection model evaluation apparatus 100 for service distribution can determine availability of the applicable object detection model on the device (operation S840).

Exemplary implementations described with reference to FIGS. 4 to 7 can be referred to in connection with operations S810 to S840.

FIG. 9 is a diagram illustrating an example of a computing device.

Referring to FIG. 9, the object detection model evaluation apparatus and method for service distribution can be implemented by using a computing device 900.

The computing device 900 can include at least one of a processor 910, a memory 930, a user interface input device 940, a user interface output device 950, and a storage device 560 communicating via a bus 920. The computing device 900 can also include a network interface 970 that is electrically connected to a network 40. The network interface 970 can transmit or receive a signal with another entity through the network 40.

The processor 910 can be implemented in various types, such as a Micro Controller Unit (MCU), an Application Processor (AP), a Central Processing Unit (CPU), a Graphic Processing Unit (GPU), a Neural Processing Unit (MPU), and the like, and can be a predetermined semiconductor device executing commands stored in the memory 930 or the storage device 960. The processor 910 can be configured to implement the functions and the methods described above with reference to FIGS. 1 to 8.

The memory 930 and the storage device 960 can include various forms of volatile or non-volatile storage media. For example, the memory can include a Read Only Memory (ROM) 931 and a Random Access Memory (RAM) 932. In some implementations, the memory 930 can be located inside or outside the processor 910, and the memory 930 can be connected with the processor 910 through already known various means.

In some implementations, at least some configurations or functions of the object detection model evaluation apparatus and method for service distribution can be implemented as programs or software executed on the computing device 900, and the programs or software can be stored on a computer-readable medium.

In some implementations, at least some configurations or features of the object detection model evaluation apparatus and method for service distribution can be implemented using hardware or circuit of the computing device 900, or can be implemented as separate hardware or circuit that can be electrically connected to computing device 900.

What is claimed is:

1. An object detection model evaluation apparatus for service distribution, the object detection model evaluation apparatus comprising:
one or more memory devices storing program codes; and
one or more processors configured to execute the program codes to perform operations comprising:
generating a data set based on a predefined service environment prior to service distribution,
designing difficulty levels for object detection based on the predefined service environment,
classifying annotations within the data set based on the designed difficulty levels,
determining applicability of an object detection model to a predefined scenario based on the classified annotations, and
determining availability of the applicable object detection model on a target device.

2. The object detection model evaluation apparatus of claim 1, wherein designing the difficulty levels comprises:
determining the difficulty levels based on at least one of a size of an input image, a number of objects, or a size of a bounding box for a single object.

3. The object detection model evaluation apparatus of claim 2, wherein designing the difficulty levels further comprises:
increasing the difficulty levels in proportion to a number of occlusions, which are objects overlapping each other.

4. The object detection model evaluation apparatus of claim 3, wherein classifying the annotations comprises:
classifying, among the difficulty levels, (i) a first difficulty level that do not exceed a predetermined first threshold as a first level, (ii) a second difficulty level that exceeds the first threshold and that does not exceed a predetermined second threshold as a second level, and (iii) a third difficulty level that exceeds the predetermined second threshold as a third level.

5. The object detection model evaluation apparatus of claim 4, wherein classifying the annotations further comprises:
setting the first threshold and the second threshold so that the first level, the second level, and the third level each occupy a specific percentage based on a histogram of the difficulty levels.

6. The object detection model evaluation apparatus of claim 4, wherein determining the applicability of the object detection model comprises:
for each level, evaluating the object detection model by using an average precision (AP) or mean average precision (mAP) index.

7. The object detection model evaluation apparatus of claim 6, wherein determining the applicability of the object detection model further comprises:
based on the evaluation of the object detection model for a first level being failed, re-learning the object detection model,
based on the evaluation for the first level being successful, performing the evaluation for a second level,
based on the evaluation for the second level being failed, evaluating the object detection model to be applicable to a first scenario, and
based on the evaluation for the second level being successful, performing the evaluation for a third level to evaluate whether the object detection model is applied to a second scenario or a third scenario according to whether the evaluation for the third level is successful.

8. The object detection model evaluation apparatus of claim 1, wherein:
determining the availability of the applicable object detection model comprises:
optimizing the object detection model with a layer supported by the target device.

9. The object detection model evaluation apparatus of claim 8, wherein determining the availability of the applicable object detection model further comprises:
inferring using an optimized object detection model, and
determining whether to use the object detection model in the target device based on a speed of inference and memory usage.

10. The object detection model evaluation apparatus of claim 1, wherein designing the difficulty levels comprises:
calculating the difficulty levels by using Equation 1,
$${Difficulty}_{i} = log ( \frac{image size + α \cdot {\sum }_{n} occlusion {area}_{n}}{bbox {size}_{i}} + 1 ) + log ( N + 1 ) \qquad [ Equation 1 ]$$
wherein, Difficulty refers to the difficulty levels, an occlusion area refers to an area that overlaps other objects based on a specific object, an image size refers to an overall size of an image, a bbox size refers to a size of a bounding box of a single object, N is a number of all objects in the image, and a is a scale parameter for a small occlusion area compared to the image size.

11. An object detection model evaluation method for service distribution that is performed by a computing device including a processor and a memory, the object detection model evaluation method comprising:
designing, by the processor, difficulty levels for object detection based on a predefined service environment;
classifying, by the processor, annotations based on the designed difficulty levels;
determining, by the processor, applicability of an object detection model to a predefined scenario based on the classified annotations; and
determining, by the processor, availability of the applicable object detection model on a target device.

12. The object detection model evaluation method of claim 11, wherein designing the difficulty levels comprises:
determining the difficulty levels based on at least one of a size of an input image, a number of objects, or a size of a bounding box for a single object.

13. The object detection model evaluation method of claim 12, wherein designing the difficulty levels further comprises:
increasing the difficulty levels in proportion to a number of occlusions, which are objects overlapping each other.

14. The object detection model evaluation method of claim 13, wherein classifying the annotations comprises:
classifying, among the difficulty levels, (i) a first difficulty level that do not exceed a predetermined first threshold as a first level, (ii) a second difficulty level that exceeds the first threshold and that does not exceed a predetermined second threshold as a second level, and (iii) a third difficulty level that exceeds the predetermined second threshold as a third level.

15. The object detection model evaluation method of claim 14, wherein classifying the annotations further comprises:
setting the first threshold and the second threshold so that the first level, the second level, and the third level each occupy a specific percentage based on a histogram of the difficulty levels.

16. The object detection model evaluation method of claim 14, wherein determining the applicability of the object detection model comprises:
for each level, evaluating the object detection model by using an average precision (AP) or mean average precision (mAP) index.

17. The object detection model evaluation method of claim 16, wherein determining the applicability of the object detection model further comprises:
based on the evaluation of the object detection model for a first level being failed, re-learning the object detection model,
based on the evaluation for the first level being successful, performing the evaluation for a second level,
based on the evaluation for the second level being failed, evaluating the object detection model to be applicable to a first scenario, and
based on the evaluation for the second level being successful, performing the evaluation for a third level to evaluate whether the object detection model is applied to a second scenario or a third scenario according to whether the evaluation for the third level is successful.

18. The object detection model evaluation method of claim 11, wherein:
determining the availability of the applicable object detection model comprises:
optimizing the object detection model with a layer supported by the target device.

19. The object detection model evaluation method of claim 18, wherein determining the availability of the applicable object detection model further comprises:
inferring using an optimized object detection model, and
determining whether to use the object detection model in the target device based on a speed of inference and memory usage.

20. The object detection model evaluation method of claim 19, wherein designing the difficulty levels comprises:
calculating the difficulty levels by using Equation 1,
$${Difficulty}_{i} = log ( \frac{image size + α \cdot {\sum }_{n} occlusion {area}_{n}}{bbox {size}_{i}} + 1 ) + log ( N + 1 ) \qquad [ Equation 1 ]$$
wherein, Difficulty refers to the difficulty levels, an occlusion area refers to an area that overlaps other objects based on a specific object, an image size refers to an overall size of an image, a bbox size refers to a size of a bounding box of a single object, N is a number of all objects in the image, and a is a scale parameter for a small occlusion area compared to the image size.
